(19) United States
(12) Patent Application Publication
(10) Pub. No.: US 2017/0295757 A1
(43) Pub. Date: Oct. 19, 2017

(54) CONTROLLABLE FEED SPRAYING DEVICE

(71) Applicant: CIXI HAOSHENG ELECTRONICS & HARDWARE CO., LTD., Cixi (CN)

(72) Inventor: JIN-JUN CAO, NINGBO (CN)

(21) Appl. No.: 15/097,299

(22) Filed: Apr. 13, 2016

(51) Int. Cl. A01K 39/01

(52) U.S. Cl. CPC A01K 39/0106

(57) ABSTRACT

The feed spraying device contains a casing member, a top cover, a side cover, a number of partitions, a loading wheel, at least a brush, a spraying wheel, a first driving unit, a second driving unit, a controller, and a power supply unit. A feed inlet is configured in the top cover. The partitions separate an inner space of the casing member into three sections. After the feed spraying device is turned on and before it stops, the controller engages the second driving unit to drive the spraying wheel to rotate for a period of time time so as to clear residual feeds in a feed storage room. In addition, the spraying wheel has blades of bended tips so as to increase the distance that the feeds are sprayed. The device therefore resolves the residual feed problem of the prior art and enhances the coverage of feed spray.

### BACKGROUND OF THE INVENTION

### (a) Technical Field of the Invention

The present invention is generally related to a device provisioning feeds to domestic animals, and more particular to a device for spraying feeds to domestic animals fanned in a wide area.

### (b) Description of the Prior Art

When domestic animals such as fowls are fanned in a wide area, the primary concern is to dispense feeds effectively so as to keep the animals healthy and well-nourished.

Conventionally, feeds are placed in an elongated feeder where the animals can take the feeds by themselves. However, some large animals may occupy the feeder and push smaller animals aside. The smaller animals therefore cannot have enough feeds and become malnourished.

A conventional feed dispensing device is provided to solve the described problem, where feeds are kept in a high place and then sprayed out by centrifugal force to make sure that every animal can have enough food. The conventional feed dispensing device has a hollow container with doors disposed on its circumferential wall. When the container is rotated up to a certain speed, feeds inside the container push open the doors and are thus sprayed around. However, the drawback is that the doors cannot be pushed open when the amount of feeds in the container is not enough.

There is another rotational feed dispensing device where a door-less container is rotated by a driving device to spray the feeds also by centrifugal force. As there is no door, no large amount of feeds are left in the container. But there are still some residual feeds in the container.

### SUMMARY OF THE INVENTION

As such the present invention provides a feed spraying device where a controller controls a second driving unit to rotate a spraying wheel for a period of time after the feed spraying device is turned on so as to clear residual feeds. The spraying wheel's blades have bended tips to increase the distance at which the feeds are sprayed. After the first driving unit stops rotating the loading wheel, the controller continues to control the second driving unit to rotate a spraying wheel for a period of time before the spraying device completely stops, so as to prevent feeds are left in the feed spraying device. The present invention therefore resolves the residual feed problem of the prior art and enhances the coverage of feed spray. Additionally, the feed spraying device has built-in driving units, and no external driving devices are necessary.

The feed spraying device contains a casing member having and a feed outlet, a top cover having a feed inlet, a number of partitions separating an inner space of the casing member into a first section, a second section, and a third section where the second section is connected to the feed inlet, the first section is connected to the feed outlet; and the first and second sections are connected via an opening on a partition separating the first and second sections. The feed spraying device further contains a loading wheel configured in the second section beneath the feed inlet, at least a brush configured in the second section along an edge of the feed inlet, a spraying wheel configured in the first section, a first driving unit configured in the third section connected to the loading wheel, a second driving unit configured in the third section connected to the spraying wheel, and a controller configured in the third section controlling the first and second driving units. Feeds are supplied into the second section through the feed inlet, sent to the first section via the opening by the loading wheel, and then sprayed out of the feed outlet by the spraying wheel.

A major objective of the present invention is that, after the feed spraying device is turned on and before it stops, the controller engages the second driving unit to drive the spraying wheel to rotate for a period of time so as to clear residual feeds in a feed storage room. In addition, the spraying wheel has blades of bended tips so as to increase the distance that the feeds are sprayed. The device therefore resolves the residual feed problem of the prior art and enhances the coverage of feed spray.

Another objective of the present invention is that the brush is made of a flexible material, and the brush has a length that the brush touches the blades of the loading wheel so as to control the entry of the feeds.

Another objective of the present invention is that a bottom side of a feed loading room is slant towards the feed storage room so as to move the feeds more smoothly.

Another objective of the present invention is that the feed storage room has a downwardly curved bottom side so as to move the feeds more smoothly.

Another objective of the present invention is that the spraying wheel has two parallel sets of blades, each set has a number of blades, each blade is bended for an angle at a tip of the blade, and each blade has a flange along a lateral side. The bended tips increase the distance that the feeds are sprayed.

Another objective of the present invention is that the loading wheel has a first connection element so as to join to the first driving unit, and the first driving unit is a motor.

Another objective of the present invention is that the spraying wheel has a second connection element so as to join to the second driving unit, and the second driving unit is a motor.

Another objective of the present invention is that the second connection element is located in a center of the casing member, an axle of the second driving unit runs through the partitions and the second connection element, and a cap covers an exposed end of the axle of the second driving unit.

Another objective of the present invention is that the feed spraying device further comprises a side cover joined to a side of the casing member by flexible elements so that the side cover is capable of being flipped open to allow access to the casing member's inside.

The feed spraying device's top cover, side cover, and partitions provide convenient manufacturing and installation of the casing member.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a feed spraying device according to an embodiment of the present invention.

FIG. 2 is a perspective exploded diagram showing the feed spraying device of FIG. 1.

FIG. 3 is a perspective diagram showing a partial inside of the feed spraying device of FIG. 1.

FIG. 4 is a cross-sectional diagram showing the feed spraying device of FIG. 1.

FIG. 5 is another cross-sectional diagram showing the feed spraying device of FIG. 1.

FIG. 6 is a perspective diagram showing the feed spraying device of FIG. 1 with a side cover opened.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

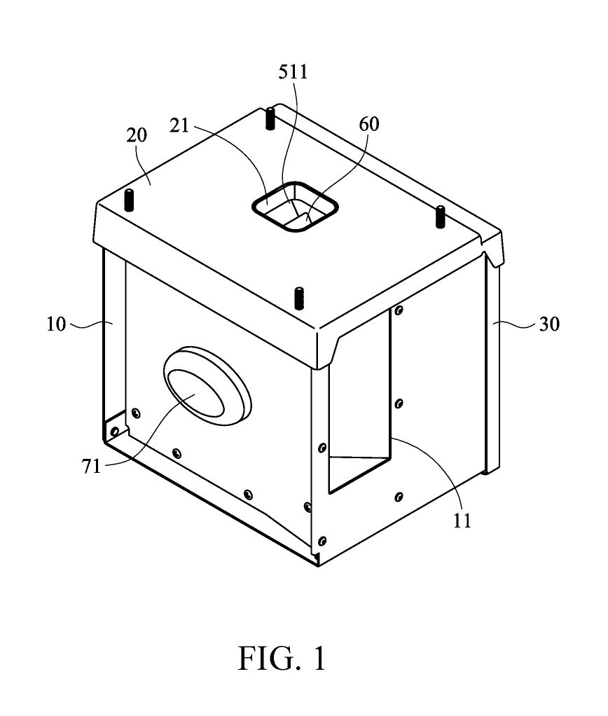

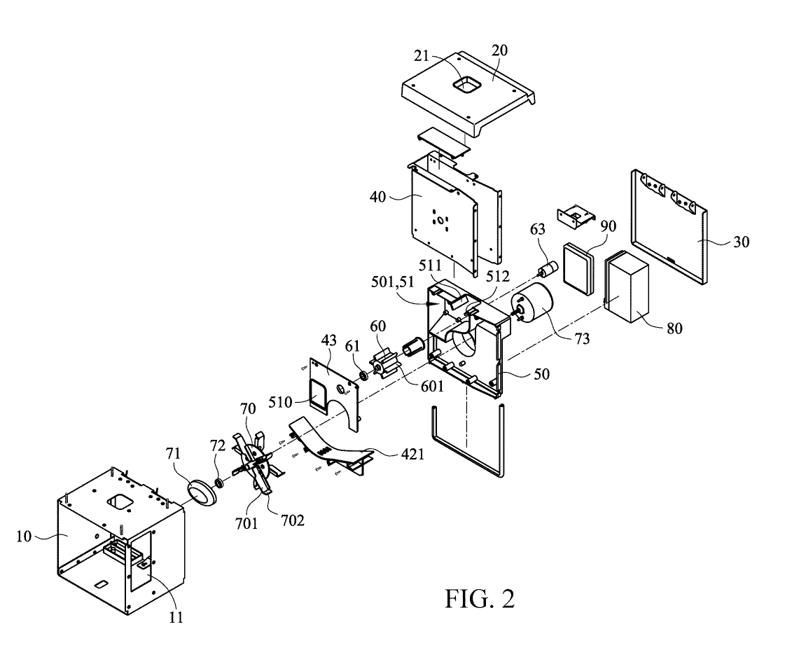

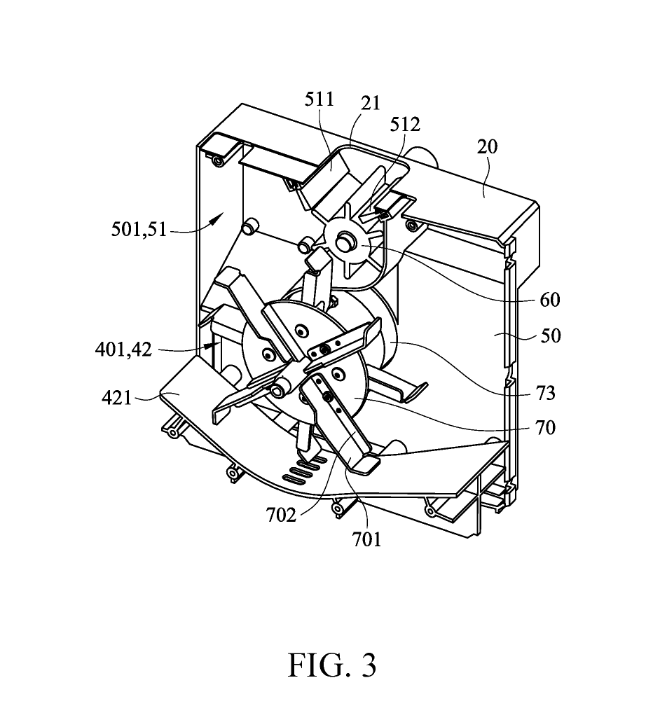

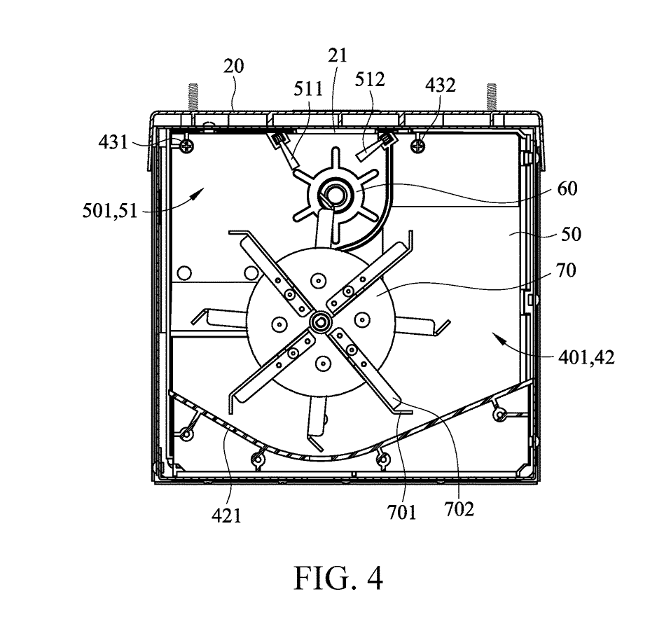

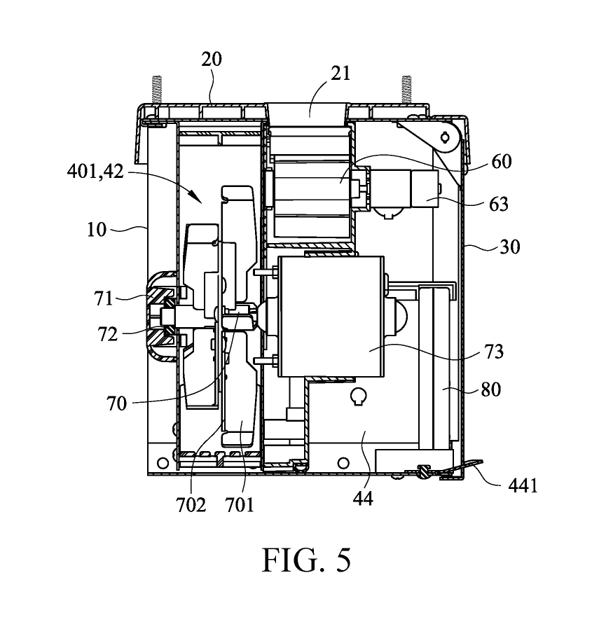

FIG. 1 is a perspective diagram showing a feed spraying device according to an embodiment of the present invention. FIG. 2 is a perspective break-down diagram showing the feed spraying device. FIG. 3 is a perspective diagram showing a partial inside of the feed spraying device. FIGS. 4 and 5 are sectional and cross-sectional diagrams showing the feed spraying device.

As illustrated, the feed spraying device includes a casing member 10, a top cover 20, a side cover 30, and a number of partitions 40, 43, and 50. A feed inlet 21 is formed in the top cover 20 through which feeds are supplied into the casing member 10, and a feed outlet 11 is formed in a side wall of the casing member 10 through which the feeds are supplied from the casing member 10. The partitions 40, 43, and 50 are configured inside the casing member 10 to divide an inner space of the casing member 10 into three sections, a first section 401, a second section 402 and a third section 403. The first section 401 is formed between the partitions 40 and 43 and serves as a feed storage room 42 connected to the feed outlet 11. The second section 501 is formed between the partitions 43 and 50 and serves as a feed loading room 51 connected to the feed inlet 21. The third section 440 is formed between the partition 40, the side cover 30, and an inner wall of the casing member 30 and serves as an accommodation space 44. The second section 501 is beneath the feed inlet 21. Two brushes 511 and 512 are configured on two opposing edges of the feed inlet 21 and extended into the second section 501. A loading wheel 60 is configured in the second section 501 beneath the brushes 511 and 512. The loading wheel 60 is connected to a first driving unit 63 configured in the third section 440's accommodation space 44, and is configured to sweep feeds from the feed inlet 21 into the feed loading room 42. A spraying wheel 70 is disposed in the first section 401 configured to sweep feeds in the feed storage room 42 out of the feed spraying device. The spraying wheel 70 is connected to a second driving unit 73 disposed in the third section 440's accommodation space 44. A controller 90 is disposed in the third section 440's accommodation space 44 and configured to control the first and second driving units 63 and 73 which rotate the loading wheel 60 and the spraying wheel 70 respectively. A power supply unit 80 is configured in the third section 440's accommodation space 44 to provide electricity for the controller 90, the first and second driving units 63 and 73. The feed loading room 51 and the feed storage room 42 are connected through an opening 510 on the partition 42 between the second and third sections 401 and 501.

As shown in FIGS. 3 and 4, when feeds are poured into the casing member 10 through the feed inlet 21, feeds are first stopped by the brushes 511 and 512, and the loading wheel 60. Then, the feed spraying device is turned on, the controller 90 starts the second driving unit 73 to rotate the spraying wheel 70 counter-clockwise for a period of time. Residual feeds in the feed storage room 42 are therefore cleared out of the feed storage room 42. After the feed storage room 42 is empty, the controller 90 starts the first driving unit 63 to rotate the loading wheel 60 clockwise. Feeds are therefore sent from the feed inlet 21 towards the feed loading room 51 and then into the feed storage room 42 via the opening 510. The feeds in the feed storage room 42 are swept by the spraying wheel 70, and sprayed out of the casing member 10 through the feed outlet 11. After no feed is left in the feed inlet 21, the controller 90 stops the first driving unit 63 and so as to stop the loading wheel 60 but maintains the operation of the second driving unit 73 and the rotation of the spraying wheel 70 for a period of time. After the feeds in the feed storage room 42 are cleared, the feed spraying device is then completely stopped.

As shown in FIGS. 3, 4, and 5, the loading wheel 60 has a number of blades 601. In the present embodiment, there are six blades 601. The brushes 511 and 512 are made of a flexible material and have a length so that the brushes 511 and 512 touch the blades 601 for stopping the feeds. A bottom side of the feed loading room 51 is slant towards the feed storage room 42 so that the feeds flow smoothly towards the feed storage room 42. The spraying wheel 70 has two parallel sets of blades 701. In the present embodiment, there are four blades 701 in each set. Each blade 701 is bended at its tip towards its spinning direction at an angle so as to increase the distance that the feeds are sprayed. Each blade 701 also has a flange 702 along a lateral side. The feed storage room 42 has a downwardly curved bottom side 421 for the smooth movement of the feeds. The curved bottom side 421 has four openings (not numbered). The loading wheel 60 has a first connection element 61 so as to join to the first driving unit 63, which is a motor in the present embodiment. The spraying wheel 70 has a second connection element 72 so as to join to the second driving unit 73, which is a motor in the present embodiment. The second connection element 72 is located in a center of the casing member 10. An axle of the second driving unit 73 extends through the partitions 40, 43, and 50, and the second connection element 72. A cap 71 covers an exposed end of the axle of the second driving unit 73.

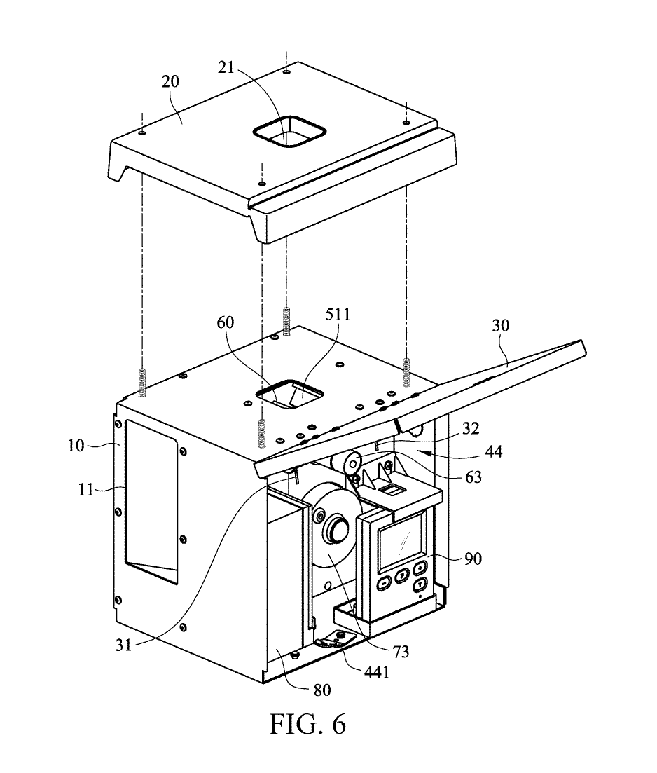

As shown in FIG. 6, the side cover 30 is joined to a side of the casing member 10 by a number of flexible elements 31 and 32. Therefore, the side cover 30 can be flipped open to allow access to the inside of the casing member 10 to facilitate assembly and maintenance.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A feed spraying device comprising:
a casing member having a feed outlet;
a top cover covering a top side of the casing member and having a feed inlet;
at least one brush disposed on an edge of the feed inlet;
a plurality of partitions dividing an inner space of the casing member into a first section, a second section, and a third section, wherein the second section is connected to the feed inlet, the first section is connected to the feed outlet; and the first and second sections are connected via an opening formed on the partition between the first and second sections
a loading wheel disposed in the second section beneath the feed inlet;
a spraying wheel disposed in the first section;
a first driving unit disposed in the third section connected to the loading wheel;
a second driving unit disposed in the third section connected to the spraying wheel; and
a controller disposed in the third section and configured to control the first and second driving units;
wherein feeds are supplied into the second section through the feed inlet, sent to the first section via the opening by the loading wheel, and then sprayed out of the feed outlet by the spraying wheel;
when the feed spraying device is turned on, the controller starts the second driving unit to rotate the spraying wheel for a period of time before the controller starts the first driving unit to rotate the loading wheel; and, before the feed spraying device completely stops, the second driving unit rotates the spraying wheel for a period of time after the first driving unit stops rotating the loading wheel so as to clear residual feeds in the second section.

2. The feed spraying device according to claim 1, wherein the second section and a feed loading room within the second section connected to the feed inlet are formed by a first partition and a second partition; the first section and a feed storage room within the first section connected to the feed outlet and the feed loading room via the opening on the first partition are formed by the first partition and a third partition.

3. The feed spraying device according to claim 2, wherein the loading wheel is located in the feed loading room and has a plurality of blades.

4. The feed spraying device according to claim 3, wherein the loading wheel has six blades.

5. The feed spraying device according to claim 4, wherein the brush is made of a flexible material; and the brush has a length that the brush touches the blades of the loading wheel.

6. The feed spraying device according to claim 2, wherein a bottom side of the feed loading room is slant towards the feed storage room.

7. The feed spraying device according to claim 2, wherein the spraying wheel has two parallel sets of blades; each set has a plurality of blades; each blade is bended at an angle at a tip of the blade; and each blade has a flange along a lateral side.

8. The feed spraying device according to claim 7, wherein each set of blades of the spraying wheel has four blades.

9. The feed spraying device according to claim 2, wherein the feed storage room has a downwardly curved bottom side with four openings.

10. The feed spraying device according to claim 1, wherein the loading wheel has a first connection element so as to join to the first driving unit; and the first driving unit is a motor.

11. The feed spraying device according to claim 1, wherein the spraying wheel has a second connection element so as to join to the second driving unit; and the second driving unit is a motor.

12. The feed spraying device according to claim 11, wherein the second connection element is located at a center of the casing member; an axle of the second driving unit extends through the partitions and the second connection element; and a cap covers an exposed end of the axle of the second driving unit.

13. The feed spraying device according to claim 1, further comprising a side cover joined to a side of the casing member by a plurality of flexible elements so that the side cover is capable of being flipped open to allow access to the casing member's inside.

14. The feed spraying device according to claim 13, wherein the side cover and an inner wall of the casing member jointly form an accommodation space.

15. The feed spraying device according to claim 1, further comprising a power supply unit configured in the third section providing electricity to the controller, the first and second driving units.
